(19) United States
(12) Patent Application Publication
(10) Pub. No.: US 2026/0277246 A1
(43) Pub. Date: Sep. 17, 2026

(54) SYSTEM AND METHOD FOR VISUALIZING POINTS OF INTEREST IN ROBOTIC AND WAREHOUSE ECOSYSTEMS

(71) Applicant: Innovative Logistics, LLC, Fort Smith, AR (US)

(72) Inventors: Ashwin Dharmesh Kumat, Fort Smith, AR (US); Yash Patil, Fort Smith, AR (US); Krunal Narottam Thakkar, Fort Smith, AR (US); Prathamesh Bhamare, Fort Smith, AR (US); Harsh Bharat Kakashaniya, Fort Smith, AR (US); Ellen Uren, Fort Smith, AR (US); Evan Foley, Arlington, TX (US); Bharath Rajiv Nair, Fort Smith, AR (US)

(21) Appl. No.: 19/566,234

(22) Filed: Mar. 13, 2026

Related U.S. Application Data
(60) Provisional application No. 63/771,863, filed on Mar. 14, 2025.

(51) Int. Cl. G05D 1/69; G05D 1/622; G05D 105/80

(52) U.S. Cl. CPC G05D 1/69; G05D 1/622; G05D 2105/87

(57) ABSTRACT

The point of interest (POI) visualization system provides systems and methods for visualizing POIs in robotic and warehouse ecosystems. The POI visualization system leverages sensor data and operational context from each autonomous mobile robots (AMR) to identify and communicate POIS which include specific locations or objects relevant to the robot's operation. These POIs may include obstacles breaching the AMR's safety field, freight locations, pick-up or drop-off points, or any other entities of significance in the AMR's environment. The identified POIs from each AMR are transmitted to a centralized robot fleet manager and displayed on a graphical user interface (GUI), providing real-time spatial visualization relative to the AMR.

### CROSS-REFERENCE TO RELATED APPLICATIONS

This applications claims priority to U.S. Provisional Application Ser. No. 63/771,863, filed Mar. 14, 2025, the entire contents of which are hereby incorporated by reference in their entirety.

### FIELD OF THE INVENTION

The present invention discloses a point of interest (POI) visualization system for real-time visualization of POIs in robotic and warehouse ecosystems.

### BACKGROUND

In modern warehouse and logistics operations, the efficient deployment and management of autonomous mobile robots (AMRs) face several challenges. Key among these is the lack of a robust system to provide real-time spatial awareness of objects, locations, and events relevant to the AMR's operation, often referred to as POIs. Current solutions are limited in their ability to offer precise visualization of such POIs, which hampers the efficiency of supervisors, teleoperators, and deployment teams.

For example, identifying and visualizing obstacles that breach a robot's safety field, determining precise pick-up and drop-off spots, or configuring intermediate navigation nodes are critical tasks in ensuring safe and efficient robot operation. In constrained environments such as narrow aisles, improper node placement can lead to safety field breaches, navigation inefficiencies, and operational delays. Furthermore, the absence of real-time feedback during AMR deployment increases the time and complexity required to configure AMRs at customer sites, negatively impacting scalability and customer satisfaction.

In the realm of warehouse automation, systems have been developed to enhance the efficiency and safety of AMRs. These solutions have mainly focused on specific aspects of AMR operation, such as navigation, obstacle detection, and task execution. However, they often lack comprehensive integration, leading to challenges in deployment, real-time monitoring, and teleoperation.

Additionally, teleoperation tasks often lack accurate guidance for positioning the AMR relative to operational nodes, such as pick-up or drop-off locations. This can result in inefficiencies, increased error rates, and reliance on manual intervention, undermining the benefits of automation.

While past solutions have advanced individual components of warehouse automation, there remains an inadequacy in systems that offer real-time visualization. The present invention addresses the aforementioned challenges by providing a comprehensive solution to visualize and manage POIs, ensuring faster deployment, enhanced safety, and improved operational efficiency in robotic and warehouse ecosystems.

### SUMMARY

The disclosed POI visualization system provides systems and methods for visualizing POIs in robotic and warehouse ecosystems. The POI visualization system leverages sensor data and operational context from each AMR to identify and communicate POIS—specific locations or objects relevant to the robot's operation. These POIs may include obstacles breaching the AMR's safety field, freight locations, pick-up or drop-off points, or any other entities of significance in the AMR's environment. The identified POIs from each AMR are transmitted to a centralized robot fleet manager and displayed on a graphical user interface (GUI), providing real-time spatial visualization relative to the AMR. This enhances the supervisor's ability to monitor and manage AMR operations effectively. Additionally, the POI visualization system assists teleoperators by dynamically indicating pick-up or drop-off spots relative to the AMR during teleoperation tasks, improving precision and efficiency.

The POI visualization system also facilitates faster deployment at customer sites by aiding in the precise configuration of operational nodes. It assists in setting pick-up and drop-off node positions, as well as intermediate navigation node locations, with real-time visual feedback.

Furthermore, the POI visualization system ensures optimal node placement in constrained environments, such as narrow aisles, to prevent safety field breaches during robot navigation. This capability streamlines deployment processes, reduces setup time, and enhances operational safety and efficiency. The disclosed invention supports integration with warehouse management systems, offering a scalable solution for managing dynamic and interactive robotic workflows.

### BRIEF DESCRIPTION OF THE DRAWINGS

FIG. 1 depicts a system diagram of the POI visualization system according to an embodiment of the present invention.

FIG. 2 depicts the data packet structure for a JSON packet according to an embodiment of the invention.

FIGS. 3 and 4 depicts example GUI screens of RFM GUI according to an embodiment of the invention.

FIGS. 5-7 illustrate the segmentation of the area surrounding the AMR into eight distinct ranges or field indicators according to an embodiment of the invention.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

The embodiments disclosed herein are for the purpose of providing a description of the present subject matter, and it is understood that the subject matter may be embodied in various other forms and combinations not shown in detail. Therefore, specific embodiments and features disclosed herein are not to be interpreted as limiting the subject matter as defined in the accompanying claims.

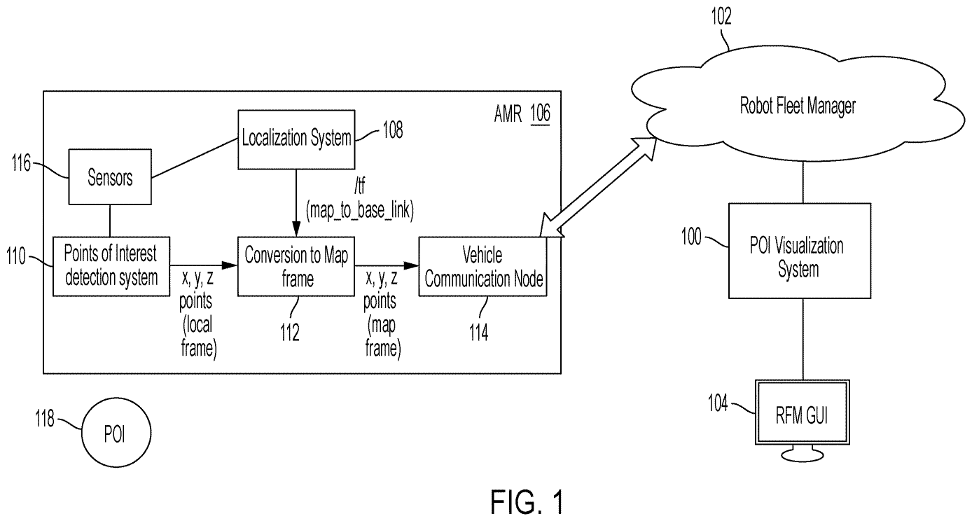

Referring first to FIG. 1, depicted is a system diagram of POI visualization system 100 and associated systems. The POI visualization system 100 communicates with each AMR 106 via robot fleet manager (RFM) 102. RFM GUI 104 allows a user to view the POI data gathered by POI visualization system 100 by each AMR 106. The gathered POI data from each AMR 106 is combined and displayed in real-time to the user on RFM GUI 104 which allows the user to monitor the state of each AMR 106 along with any detected POIs 118 that may need to be addressed or handled, such as obstacles within the environment or path of an AMR 106. For example, RFM GUI 104 may display an overhead view of the facility containing the AMRs 106 along with any detected POIs 118. The position of each AMR 106 on the overhead view can be updated in real-time using location information received from each AMR 106 as will be described later.

RFM 102 may provide other functionality such as monitoring the status of each AMR 106, assigning tasks (e.g., pickups or drop-offs), and planning routes and reroutes for AMRs 106. An RFM 102 at a first facility may be coupled to a RFM 102 at a remote facility, allowing management of multiple sites or facilities from a single location. For example, RFM GUI 104 may allow a user to view an overhead map of the remote facility and/or the first facility.

Each AMR 106 comprises sensors 116, localization system 108, POI detection system 110, conversion system 112, and vehicle communication node 114. Sensors 116 may comprise 2D LIDAR (Light Detection and Ranging), cameras (visible light or infrared), or other sensors to detect obstacles, objects, and key operational points such as pick-up locations or drop-off locations. Using data from sensors 116, POI detection system 110 calculates the position of each detected POI 118 in the local coordinate frame (x, y, z) of AMR 106. The local coordinate frame is defined relative to the physical body of each AMR 106.

To communicate the position of POIs 118 effectively to the RFM 102, conversion system 112 converts the local coordinates of each POI 118 into a global coordinate that is consistent across the warehouse ecosystem for each AMR 106. This is achieved using localization system 108 which calculates the transformation matrix between the AMR's base link (the AMR's center of reference) and the global coordinate system. The x, y, z position of each POI in the local coordinate frame is converted to the global coordinate frame using the transformation matrix by conversion system 112, ensuring global consistency across all AMRs 106.

Vehicle communication node 114 aggregates POI data with other operational details into a unified communication packet including vehicle status and POI data. Vehicle status includes information such as the current position, velocity, battery status, and mission details of AMR 106. POI data includes a position in the global coordinate frame for each POI 118 along with additional metadata (e.g., object type, timestamp, relevance). The vehicle communication node 114 aggregates the vehicle status and POI data into a JSON (JavaScript Object Notation) packet.

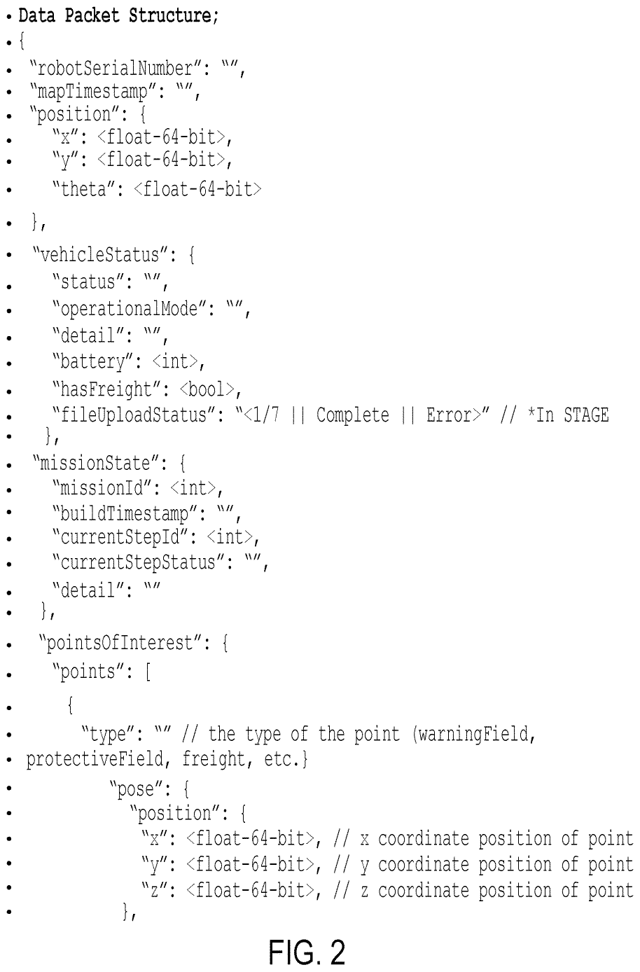

Vehicle communication node 114 communicates with RFM 102 using a REST API architecture in an embodiment of the invention. This ensures reliable and scalable data exchange. Preferably, vehicle communication node 114 transmits the JSON packet to RFM 102 at a predetermined frequency (e.g., 1 Hz) as a HTTP POST Request. FIG. 2 depicts an example data packet structure for the JSON packet. This ensures near real-time updates to RFM GUI 104 without overloading available network bandwidth.

POI visualization system 100 receives the JSON packets from each AMR 106 and processes it for visualization using RFM GUI 104. Specifically, POI visualization system 100 plots the global x, y, z coordinate of each detected POI 118 on RFM GUI 104 (e.g., on a warehouse layout). Additional details associated with each POI 118, such as type (e.g., obstacle, pick-up, drop-off) are displayed as tooltips or labels to aid the supervisor and provide additional context. RFM GUI 104 is refreshed at or near the packet transmission rate (e.g., 1 Hz) to provide real-time visualization of the location of each AMR 106 and detected POI 118.

The POI visualization system 100 facilitates faster deployment at customer sites by:
Node Placement: Supervisors can visualize and adjust the positions of pick-up/drop-off nodes and intermediate navigation nodes directly on the RFM GUI 104.
Narrow Aisle Validation: The POI visualization system 100 ensures that node placement does not cause safety field breaches when the AMR 106 navigates to these locations.

POI visualization system 100 can help with safety field breaches of AMRs 106. POI detection system 110 identifies any POIs 118 that breach a safety field surrounding the AMR 106. The local coordinates of the POI 118 are determined in the local coordinate frame and are converted to the global coordinate frame by conversion system 112. Vehicle communication node 114 transmits the global coordinates to the POI visualization system 100 using a JSON packet as already described. The POI 118 can then be viewed on RFM GUI 104 almost immediately after it is detected by AMR 106.

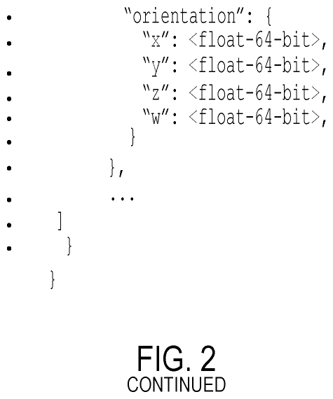

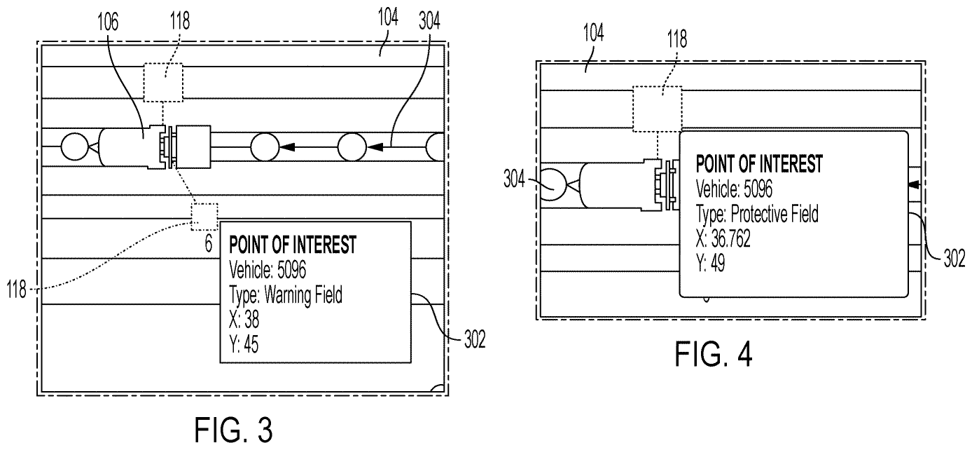

FIGS. 3 and 4 depicts example screens of an AMR 106 on RFM GUI 104 after a POI 118 has been detected and displayed. RFM GUI 104 allows a user to select each POI 118 independently to display additional information 302 about POI 118. The path 304 of each AMR 106 may also be displayed on RFM GUI 104. If a user selects the other displayed POI 118 as depicted in FIG. 4, additional information 302 about the newly selected POI 118 is displayed.

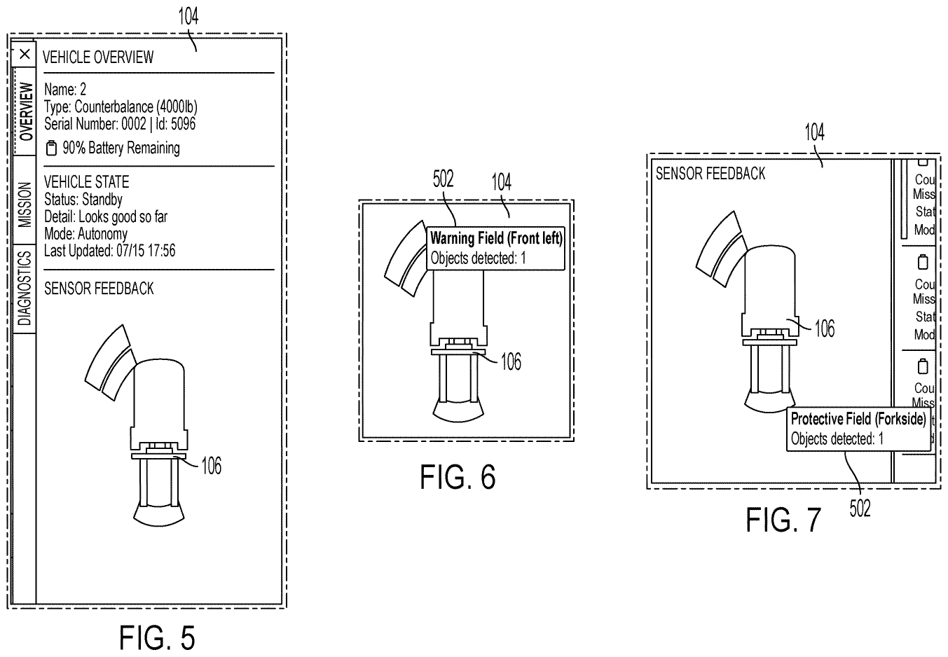

FIGS. 5-7 illustrate the segmentation of the area surrounding the AMR 106 into eight distinct ranges or field indicators 502: front, front-left, front-right, left, right, forkside, forkside-left, and forkside-right that may be displayed on RFM GUI 104. POIs 118 detected within these fields are grouped accordingly, providing a clear spatial representation of their relative positions to the AMR 106. This grouping aids in visualizing and categorizing POIs 118 for further processing and display on the RFM GUI 104.

### System Advantages

Real-Time Visualization: By leveraging sensor data and localization systems, POI visualization system 100 enables real-time identification and display of POIs 118 relative to each AMR 106 on RFM GUI 104. This reduces latency in monitoring and decision-making.
Dynamic Context Awareness: The POI visualization system 100 can dynamically represent POIs, including freight locations, pick-up/drop-off points, and safety field breaches, ensuring comprehensive spatial awareness.
Faster Node Setup: The POI visualization system 100 supports faster deployment at customer sites by facilitating the placement of pick-up, drop-off, and intermediate navigation nodes. It ensures that these nodes are positioned accurately within the warehouse environment, even in narrow aisles, without breaching safety fields.
Reduced Configuration Effort: Precise node placement reduces manual efforts and time, enabling quicker integration with customer-specific workflows.
Centralized Data Processing: The use of REST API-based communication and integration with existing robot fleet manager systems minimizes the need for additional hardware, reducing implementation and maintenance costs.
Scalability: The modular design of POI visualization system 100 and compatibility with warehouse management systems ensure it can scale with expanding operational requirements, minimizing long-term costs.
Safety Field Monitoring: POI visualization system 100 identifies and communicates obstacles breaching the AMR's 106 safety field, providing supervisors with precise spatial data to ensure safer navigation.
Improved Teleoperation: During teleoperation tasks, the POI visualization system 100 provides visual cues for pick-up and drop-off points relative to the AMR 106, improving precision and reducing the risk of accidents.
Comprehensive POI visualization system 100 integrates various types of POIs 118 into a unified framework, providing holistic situational awareness.
Adaptability: The ability to adapt POI visualization system 100 for additional use cases, such as tracking freight positions or configuring intermediate nodes, ensures its relevance in diverse warehouse environments and provides a competitive advantage over static or limited-functionality systems.
Seamless Integration: The use of the AMRs 106 to aggregate data from the perception and localization systems into a single REST API packet showcases technical elegance and operational efficiency.
Future-Ready Design: The modular and extensible nature of POI visualization system 100 allows for integration with advanced features like AI-driven decision-making or enhanced visualization tools, preparing it for future technological advancements.
Energy Efficiency: By reducing deployment time and optimizing AMR operations, the POI visualization system 100 contributes to energy-efficient warehouse workflows.
Minimized Disruptions: Real-time updates and precise visualization on RFM GUI 104 reduce operational downtime, ensuring smoother logistics and warehouse operations.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A point of interest (POI) visualization system comprising:
a plurality of autonomous mobile robots (AMR) positioned in a logistics environment;
a robot fleet manager (RFM) for managing the plurality of AMRs
wherein each AMR comprises:
a plurality of sensors;
a POI detection system for detecting POIs in a vicinity of the AMR using data from the plurality of sensors;
a localization system for determining local coordinates of the POIs relative to the AMR;
a conversion system for converting the local coordinates to global coordinates of the logistics environment; and
a communication module for transmitting POI information and the local coordinates for all detected POIs in real-time to the RFM;
a POI visualization system for adding the POI information and the local coordinates for all detected POIs to a map of the logistics environment; and
a RFM graphical user interface (GUI) for simultaneously displaying a real-time location of the plurality of AMRs and the detected POIs,
wherein the detected POIs are utilized by the RFM in planning routes for the plurality of AMRs.

2. The POI visualization system of claim 1, wherein the plurality of sensors include a camera and a light detection and ranging (LIDAR) sensor.

3. The POI visualization system of claim 1, wherein the POI information includes dimensions and a type of each detected POI determined by the localization system.

4. The POI visualization system of claim 1, wherein detected POIs from a first AMR of the plurality of AMRs are communicate to all other AMRs of the plurality of AMRs.

5. The POI visualization system of claim 1, wherein the plurality of AMRs communicate their local coordinates to the RFM in real-time for display on the map.

6. The POI visualization system of claim 1, wherein selection of a detected POI on the map displays the POI information associated with the detected POI.

7. The POI visualization system of claim 6, wherein the selection further displays a label and a type for each detected POI.

8. The POI visualization system of claim 1, wherein the POI detection system classifies the detected POIs as obstacles or freight.

9. The POI visualization system of claim 8, wherein detected POIs that are classified as obstacles are displayed on the RFM GUI in a first color on the map.

10. The POI visualization system of claim 9, wherein detected POIs that are classified as freight are displayed on the RFM GUI in a second color different than the first color.

11. The POI visualization system of claim 1, wherein the communication module transmits the POI information, the local coordinates, and AMR position in a packet using a REST API architecture.

12. The POI visualization system of claim 11, wherein the packet is a JSON packet transmitted at a predetermined frequency.
